(19) United States
(12) Patent Application Publication
(10) Pub. No.: US 2018/0128165 A1
(43) Pub. Date: May 10, 2018

(54) Power Supply System and Control Method of Power Supply System

(71) Applicant: Hitachi, Ltd., Tokyo (JP)

(72) Inventors: Noriaki HINO, Tokyo (JP); Mamoru KIMURA, Tokyo (JP); Masatoshi YOSHIMURA, Tokyo (JP); Kazuhiro MAEZAWA, Tokyo (JP)

(21) Appl. No.: 15/801,344

(22) Filed: Nov. 2, 2017

(30) Foreign Application Priority Data
Nov. 8, 2016 (JP) 2016-217723

(51) Int. Cl. F02B 63/04; F03D 9/11; H02S 40/38; H02S 10/10

(52) U.S. Cl. CPC F02B 63/042; H02S 10/10; H02S 40/38; F03D 9/11

(57) ABSTRACT

Abrupt output fluctuation of renewable energy is smoothed by output control of a prime mover driven generator and curtailment of renewable energy. The generator is a doubly-fed induction generator and a rotor creates a rotating magnetic field by being energized with AC through a power converter and makes a frequency of the AC variable so as to change speed of the rotor and receive and output inertial energy that the rotor has. In a case where an output of renewable energy is abruptly increased and curtailment of the prime mover is not made in time, output fluctuation is smoothed by suppressing the output of renewable energy at the same time while increasing the speed of the rotor to be absorbed as inertial energy.

### BACKGROUND OF THE INVENTION

### Field of the Invention

The present invention relates to a power supply system and a control method of the power supply system, and particularly to a power supply system suitable for generating power including renewable energy of which output fluctuates and a control method of the power supply system.

### Background Art

In order to realize a sustainable society without relying on fossil fuels as energy, renewable energy capable of being obtained by such as photovoltaic power generation or wind power generation is rapidly spreading. However, outputs of the photovoltaic power generation and wind power generation are affected by environmental conditions, wind and sunlight intensity of solar light are successively changed and thus, there is a concern that output of power generation fluctuates and the entire power system becomes unstable. The power needs to be kept stable at any moment in its output and load, that is, its supply-demand balance and thus, output fluctuation of renewable energy needs to be supplemented by another power supply.

In order to compensate for the output fluctuation, power of a prime mover driven generator such as thermal power or hydraulic power needs to be changed according to the load. The more the renewable energy increases, the more the adjustment range becomes larger. In recent years, adjustment capability of a power generation facility of the related art alone is not sufficient for the adjustment.

In contrast, in the power generation facility driven by a diesel engine, a gas engine, or hydraulic power, fluctuation of a system power is suppressed using inertial energy, that the prime mover and the generator have, by excitation control using inertial energy of a generator, that is, by changing a frequency of power to be applied to a rotor of a doubly-fed synchronous machine and absorbing power fluctuation of a system using the doubly-fed synchronous machine having an AC excitation power supply of a variable frequency as the generator, against fluctuation of a short period. On the other hand, against slow fluctuation, fluctuation of the system power is suppressed by changing fuels to be supplied to the prime mover and changing mechanical energy generated by the prime mover. Such a technology is described in, for example, JP-A-2006-320080.

### SUMMARY OF THE INVENTION

However, as in the recent years, when renewable energy is increased with respect to a prime mover driven generator of which the output is adjustable (for example, when renewable energy is increased to a proportion that exceeds 30%), in the technology of JP-A-2006-320080 described above, although it is possible to respond to the fluctuation of the relatively short period and the slow fluctuation, it is unable to follow “intermediate period fluctuation” between fluctuation of the relatively short period and the slow fluctuation.

The present invention is made by taking the problems to be solved into consideration and has an object to provide a power supply system capable of suppressing output fluctuation in an intermediate period in a power generation system including renewable energy and a control method of the power supply system.

In order to achieve the object described above, according to one aspect of the present invention, there is provided a power supply system which is configured to include a prime mover that utilizes fuel, a doubly-fed rotarymachine that is connected to the prime mover and generates power, a power converter that is connected to a rotor of the doubly-fed rotary machine, and a renewable energy power supply, and in which frequency control is performed against fluctuation of a system having a first period by the power converter, curtailment control is performed on an output of the renewable energy against fluctuation of the system having a second period longer than the first period, and the prime mover is controlled against fluctuation of the system having a third period longer than the second period.

More specifically, in a hybrid power generation system configured with a prime mover utilizing fuel, a doubly-fed rotary machine connected to a shaft of the prime mover, a power converter supplying AC power to a rotor of the doubly-fed rotary machine, and a renewable energy power supply, in a case where power is excessive, control is made in such a way that curtailment control is performed on an output of the renewable energy at the same time while frequency control is performed on AC power to be supplied to the rotor of the doubly-fed induction generator to increase rotation speed so as to absorb power as inertial energy.

Furthermore, the hybrid power generation system includes a secondary battery and in a case where power is insufficient, control is made in such a way that an output is supplemented by the secondary battery.

Control is made in such a way that prediction of renewable energy output is performed and rotation speed of the doubly-fed induction generator is changed in advance according to the prediction.

According to the present invention, it is possible to suppress fluctuation of an intermediate period while using inertia of the generator against power fluctuation mainly caused by renewable energy.

### BRIEF DESCRIPTION OF THE DRAWINGS

FIG. 1 illustrates an example of a configuration of a hybrid power generation system according to a first embodiment of the present invention.

FIG. 2 illustrates an example of matters that apparatuses capable of coping with respective fluctuation components to be suppressed are different in the present invention.

FIGS. 3A to 3E illustrate an example of a control method of the hybrid power generation system of the present invention.

FIG. 4 illustrates an example of a control method of a hybrid power generation system according to a second embodiment of the present invention.

FIG. 5 illustrates an example of a control method of a battery in a system of a referential example.

FIG. 6 illustrates an example of a configuration of a hybrid power generation system according to a third embodiment of the present invention.

FIG. 7 illustrates an example of a control method of a hybrid power generation system according to a fourth embodiment of the present invention.

FIG. 8 illustrates an example of a configuration of a hybrid power generation system according to a fifth embodiment of the present invention.

### DETAILED DESCRIPTION OF THE INVENTION

In the following, an example for embodying the present invention (in the following, denoted by an “embodiment”) will be described with reference to the accompanying drawings. In all the drawings used for describing embodiments, the same reference numerals are basically given to the same members and redundant descriptions thereof will be appropriately omitted.

### Embodiment 1

A power supply system of a first embodiment according to the present invention will be described using FIG. 1.

A hybrid power generation system 9 is configured with a renewable energy supply 5, a secondary battery 3, and a doubly-fed induction generator 2 connected to a prime mover 1. The doubly-fed induction generator 2 is configured with a rotating machine part of a rotor 10 and a stator 11 and a frequency converter 20. The rotor 10 is connected to the prime mover 1 through a shaft 12. The output of the prime mover is controlled by an input amount of fuel. A power line connected to the stator 11 is energized with AC in synchronization with a system. The rotor 10 is driven by the prime mover 1. The rotor 10 is energized with DC or a low frequency AC from the frequency converter 20.

The doubly-fed induction generator 2 is controlled by the control apparatus 21 and communicates with the converter 20 and a power meter 13. The power converter control apparatus 21 drives the converter 20 so that power of the power meter 13 becomes desired power. A power value observed by the power meter 13 is a total of power from the power converter and power from the stator 11 of the generator and in the following, the power from the stator 11 is called a prime mover output and the output from the frequency converter 20 is called an inertial energy output. Power from the renewable energy supply 5 is called a renewable output.

An integrated control device 22 is connected with respective apparatuses by communication, controls all apparatuses, and monitors and controls the output of the hybrid power generation system 9 in its entirety.

The operations of the doubly-fed induction generator 2 will be described. In a case where the rotor 10 is energized with DC, the rotor l0 rotates at speed of a synchronous generator. If the number of poles of the rotor is P and a frequency of a system is f (Hz), a rotation number N (rpm) is expressed as the following expression.

N=f×60/(P/2) (Expression 1)

Next, for example, three-phase AC of a frequency fᵣ is made to flow from the frequency converter 20. In a case where a direction of a magnetic field created by the rotor 10 due to the three-phase AC is the same as a rotation direction of the rotor 10, the rotor 10 rotates at the following speed N₁.

N₁=(f−fᵣ)/(P/2) (Expression 2)

In a case where the direction of the magnetic field created by the rotor 10 is opposite to the rotation direction of the rotor 10, the speed N₂ becomes as follows.

N₂=(f+fᵣ)/(P/2) (Expression 3)

In the following, a direction of a magnetic field created by three-phase AC generated by the converter 20 is represented by a sign of a frequency, and it is defined that a negative sign indicates a rotation direction and a positive sign indicates a direction opposite to the rotation direction. According to this definition, when the frequency is increased in the positive direction, rotation speed of the shaft is increased and when the frequency is decreased in the negative direction, the rotation speed of the shaft is decreased.

In this case, rotational inertial energy E₁ and E₂ that the rotor 10 has is expressed as the following expression by using moment of inertia J that the shaft of the generator has.

E₁=(1/2)·J·ω₁² (Expression 4)

E₂=(1/2)·J·ω₂² (Expression 5)

ω₁=2πN₁/60 (Expression 6)

ω₂=2πN₂/60 (Expression 7)

When the frequency of the frequency converter 20 is changed from +fᵣ to −fᵣ the rotation speed is decreased from N₂ to N₁. During the course of change in the frequency of the frequency converter 20, if a constant output is given to the shaft 12 from the prime mover 1, change ΔE of rotational inertial energy that the rotor 10 has is released to a system and an amount of the fluctuation is expressed as the following expression.

ΔE=E₂−E₁ (Expression 8)

ΔE can be regarded as a separate power supply which can be separately subjected to output control by the doubly-fed induction generator 2 other than the output control of the prime mover by the doubly-fed induction generator 2. ΔE is determined by an upper limit N₂ and a lower limit N₁ and moment of inertia J of the rotation speed determined from limitations of the prime mover and the generator. In the system of the present embodiment, moment of inertia J is a total of rotational moment of inertia of the generator and the prime mover.

Here, it may be estimated that a relationship between the output fluctuation generated by renewable energy and the period, which can be suppressed by the inertial energy ΔE. It is assumed that output fluctuation is a sine wave having a period of T and amplitude of B. A width of the output fluctuation is ±B. When an integrated value of one period of the output fluctuation waveform is smaller than ΔE, the waveform can be suppressed by ΔE and a relationship between the fluctuation width and the period becomes as follows.

ΔE=BT/(2π) (Expression 9)

That is, the shorter the fluctuation period T, the larger the fluctuation width B can be suppressed for the inertial energy.

The amplitude B of the fluctuation and the period T are specifically estimated in an actual system. Although moment of inertia J is an inherent value of the generator and the prime mover, a per-unit inertia constant H (unit: sec) used in a model for system analysis or the like is generally known. If a rated rotation speed is N₀, a rated apparent power is VA₀, and inertial energy at the rated speed is E₀, the inertia constant H normalized by the output of the generator is defined by the following expression.

H=E₀/VA₀ (Expression 10)

E₀=(1/2)·J·ω₀² (Expression 11)

ω₀=2πN₀/60 (Expression 12)

As expressed in Expression 10, the inertia constant H means that all rotational energy is released in H seconds if the rated output is output using inertial energy of the shaft that the generator has during rated rotation. Depending on the type of generator, the inertia constant H is approximately three to six seconds for a large steam generator, approximately three seconds for a medium gas turbine generator, and approximately one to two seconds for a small diesel generator.

The shaft 12 is connected directly to the prime mover and thus, the rotation thereof cannot be stopped during operation, and a variable speed range is limited. When it is assumed that the width thereof is N₀±C %, ΔE is expressed as the following expression.

ΔE=E₀·{(100+C)²−(100−C)²}/100² (Expression 13)

Here, from three expressions of Expression 9, Expression 10, and Expression 13, a relationship between the fluctuation amplitude B and the period T using the H and C becomes as follows.

B₀·T=2π·H·{(100+C)²−(100−C)²}/100² (Expression 14)

B₀=B/VA₀ (Expression 15)

Expression 14 indicates that components having faster fluctuation periods can cope with larger fluctuation widths in the inertial energy. With these, it is possible to estimate ΔE using a general H.

Next, a fluctuation width capable of being suppressed by output change speed of the prime mover and a period will be estimated. In general, the prime mover 1 is limited by the maximum temperature inside a thermal engine, deformation due to heat, or the like and there is an upper limit on an output changing rate d (%/min). The prime mover is able to change the output from 50% to 100%, for example, and thus, the prime mover is able to cope with a slow and large change. If a relationship between the period T and the amplitude B where output change determined by the output changing rate d matches is obtained when a sine wave is used as a waveform of the fluctuation output and the inclination of the output change is maximized, it becomes the following equation.

B₀=d·T/(2π·60) (Expression 16)

In general, a rated output ratio is approximately 2 to 3%/min for a large steam generator, 5 to 10%/min for a medium gas turbine generator, and approximately 100%/min for a small diesel generator. Accordingly, output fluctuation that is possible with the output control of the prime mover becomes to have a period of one minute or more.

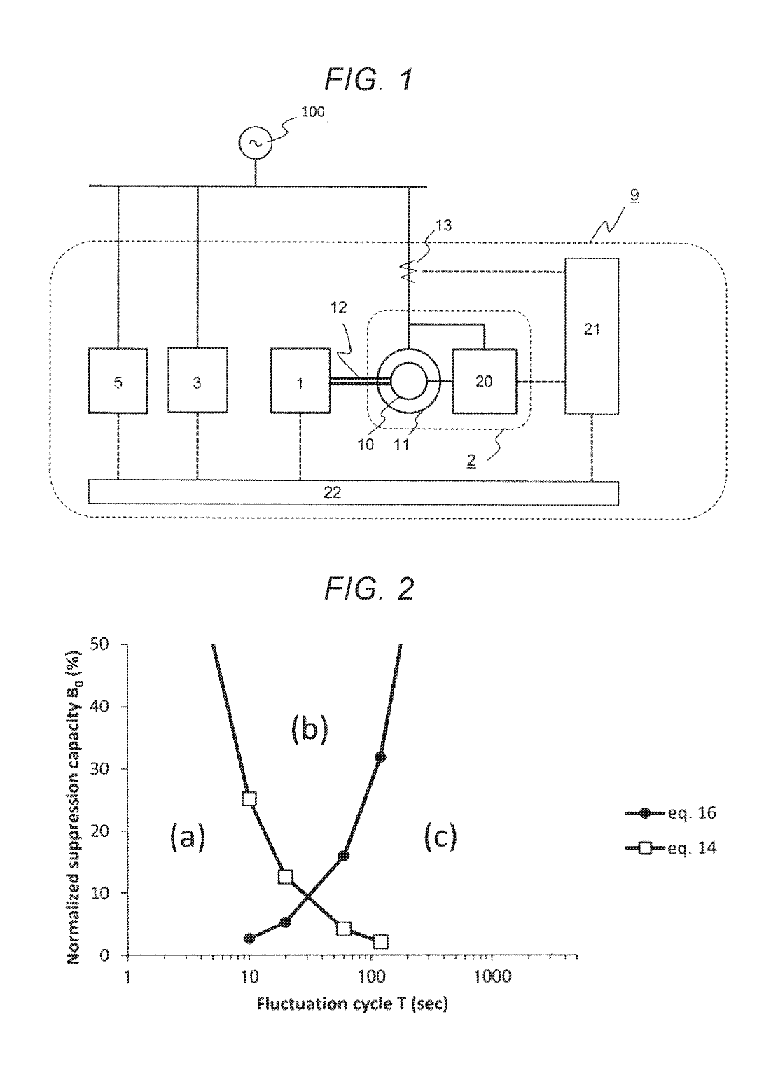

Using Expression 14 and Expression 16 described above, a trial calculation is specifically done by using numerical values indicated in Table 1 by assuming that the small diesel generator is used. The variable speed range of the shaft was set as ±10%. When the period T of sine wave fluctuation is set as the horizontal axis and the amplitude B₀ is set as the vertical axis, lines representedby Expression 14 and Expression 16 are illustrated in FIG. 2.

TABLE 1

| | Symbol | Unit | Value |
|---|---|---|---|
| Inertia | H | sec | 1 |
| Speed range | C | ± % | 10 |
| Ramp rate | d | %/min | 100 |

The region (a) of FIG. 2 has amplitude smaller than Expression 14 and thus, the region (a) indicates that it is possible to follow such a change in the output width by inertial energy, and is a regionwhere fluctuation suppression is possible. The region (c) having the amplitude smaller than Expression 16 indicates that it is possible to cope with the region (c) by output control of the prime mover. As will be understood from the FIG. 2, it is unable to change the output in the region (b) by either method. For example, against fluctuation of a period having 30 seconds becomes unable to follow up to only approximately 10% of the output of the generator.

For that reason, in order to suppress fluctuation in the (b) region, another means, for example, the means for suppressing charging and discharging by the secondary battery and fluctuation of renewable energy itself are needed.

The present embodiment is a hybrid power supply system which provides a control method suitable for each of the regions (a), (b), and (c) according to a fluctuation period of renewable energy.

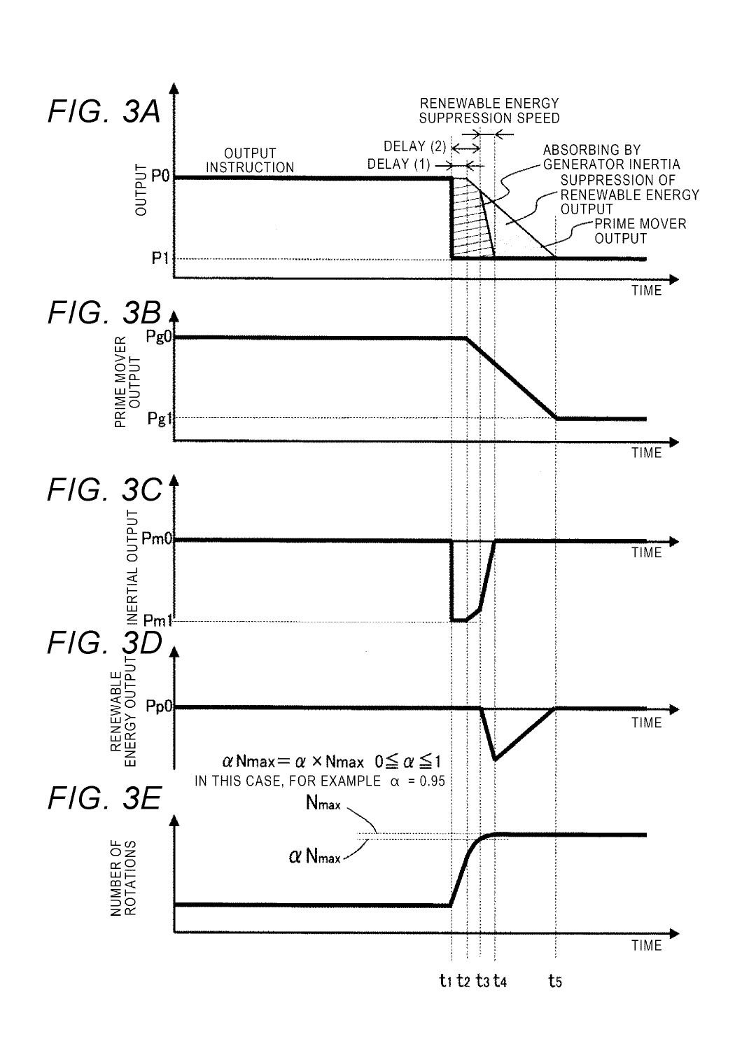

FIGS. 3A to 3E illustrate power supply form of the power supply system according to the present embodiment. FIG. 3A illustrates a power instruction to be given to the integrated control device 22. FIG. 3B illustrates an output of the prime mover. FIG. 3C illustrates an output of inertial energy (in the figure, denoted by “inertia output” for short). FIG. 3D illustrates a renewable output. FIG. 3E illustrates the number of rotations of the prime mover 1.

At time t₁, the integrated control device 22 is instructed to narrow the output from P₀ to P₁. In response to the instruction, the integrated control device 22 distributes a control instruction to each of the prime mover 1, the frequency converter 20, and the renewable energy supply 5. Here, until time t₁, the integrated control device 22 distributes the control instruction to each of the prime mover 1, the frequency converter 20, and the renewable energy supply 5 such that prime mover output P_{q0}+inertial energy output Pₘ₀ (typically 0)+renewable energy output Pₚ₀=instruction P₀ of integrated control device 22.

At time t₁, the integrated control device 22 gives an instruction to the prime mover 1 so that prime mover output P_{q1}=prime mover output P_{q0}−(P₀−P₁). However, since there is an upper limit on the output change speed of the prime mover output, even if a required output drops stepwise like a thick line in the figure, the prime mover output does not change immediately. First, there is a signal delay (1), and then the output decreases at a ramp rate (output change rate).

At this time, the integrated control device 22 gives an instruction to the frequency converter 20 so as to fill up the difference between the prime mover output and an instruction value. That is, the frequency of the frequency converter 20 is lowered to raise the number of rotations (speed) of the rotor 10 so that the surplus is absorbed by inertial energy having fast response. That is, the integrated control device 22 gives an instruction to the frequency converter 20 so that inertial energy output Pₘ₁=Pₘ₀−(P₀−P₁). The time change of the number of rotations of the prime mover 1 becomes inertial energy and is outputted.

At time t₂, the output of the prime mover drops at the ramp rate from t₂ to t₃ after the signal delay (1) from the prime over output P_{g0}. In compliance with the drop of the prime mover output, an amount to be absorbed by the inertial energy output is decreased. That is, the integrated control device 22 distributes the control instruction to the prime mover 1 and the frequency converter 20 so as to raise the inertial energy output by the amount corresponding to the decrease in the prime mover output. Following this, rising of the number of rotations of the prime mover 1 becomes little gentle.

At time t₃, after the delay (2) of the signal from the prime mover output P_{g0}, the number of rotations of the prime mover 1 reaches αNmax (=α×Nmax 0≤α≤1, α=0.95 in the present embodiment) and the surplus of the prime mover output becomes unable to be sufficiently absorbed by the inertial output. For that reason, the integrated control device 22 gives a control instruction to the frequency converter 20 so that the inertial energy output gradually returns to Pₘ₀. At time t₃ to t₄, the increase in the number of rotations of the prime mover 1 becomes more gentle by that amount. On the other hand, the integrated control device 22 distributes the control instruction to the renewable energy supply 5 so as to cause the regenerative energy output to decrease gradually from P_{P0} so that the total output of the prime mover output, the inertial energy output, and the regenerative energy output is maintained at P₁.

At time t₄, the number of rotations of the prime mover 1 reaches Nmax and thus, the inertial energy output becomes Pₘ₀(=0). For that reason, the integrated control device 22 distributes the control instruction to the renewable energy supply 5 so that the total output of the prime mover output, the inertial energy output (inertial energy output=Pₘ₀), and the regenerative energy output is maintained at P₁.

At time t₅, the prime mover output becomes P_{g1} and thus, the integrated control device 22 distributes the control instructions so that the inertial energy output becomes Pₘ₀ (=0) and the regenerated energy output becomes P_{P0}.

As such, since there is an upper limit on the output change speed of the prime mover output, there is a signal delay (1), and then the signal decreases at the output change rate. In this case, in order to fill up the difference between the prime mover output and the instruction value, first, the frequency of the frequency converter 20 is lowered to raise the speed of the rotor 10 so that the surplus is absorbed by the inertial energy having fast response.

When the amplitude is large, the inertial energy is insufficient and the rotation speed reaches the upper limit and thus, an instruction is sent from the integrated control device 22 so as to narrow the output of the renewable energy supply 5 and control is made to suppress the output. A renewable energy supply is configured with the photovoltaic power generation apparatus, a wind power generator, or the like. That is, in the region (b) that the region (a) cannot cope with in FIG. 2, when it is intended to abruptly lower the large output, the renewable energy is suppressed. Normally, renewable energy is controlled so as to be the maximum output obtained from the external natural environment, it is impossible to increase the output, but it is possible to reduce the output. For example, in the photovoltaic power generation apparatus, output can be stopped by blocking gates with an inverter, and in the wind power generator, a pitch angle of wings is controlled so as to make it possible to reduce input. However, the outputs of the generation apparatus and the generator are delayed due to the communication period with the integrated control device and the activation time of the apparatus and thus, the difference during the delay is absorbed by the inertial energy of the doubly-fed power generation device as described above.

### Embodiment 2

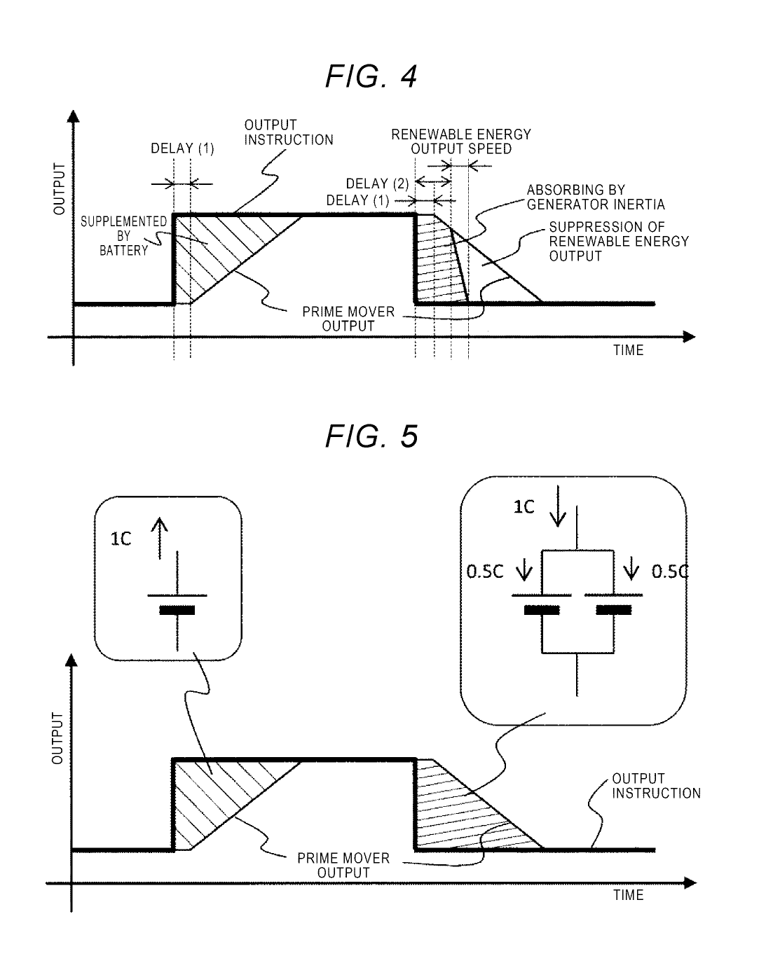

FIG. 4 illustrates another embodiment of the present invention. Here, power supply form in the case where the output is increased in a stepwise manner in the configuration described in the first embodiment is illustrated. The second embodiment is different from the first embodiment in that the secondary battery 3 illustrated in FIG. 1 is used. In an actual use example of the secondary battery, it is possible to instantaneously output effective power like an uninterruptible power supply at instantaneous power failure. On the other hand, as illustrated in FIG. 4, the output of the prime mover has a delay (1) due to a control period, a detection delay, or the like and the output change rate is limited, so that the output is only gradually increased. For that reason, power of a hatched line portion is supplemented by the secondary battery. In the case of lowering the output in a stepwise manner, the same operation as in the first embodiment is performed. That is, in the present embodiment, and apparatuses controlling the output and roles thereof are different in the case of increasing the output and in the case of decreasing the output.

In the case of simply supplementing excess or deficiency of the output by using the secondary battery, it becomes FIG. 5 (reference example). However, if a lead-acid battery, which is a representative secondary battery, is used, when it is intended to fill the difference between the instruction value and the output of the prime mover with only the battery, the required amount of the battery is increased and cost is increased. It is known that a current output rate of the lead-acid battery is different between a case of discharge and a case of charge. There is a C rate as a unit representing the current output rate. The C rate is expressed as a value obtained by dividing the charge and discharge current of a storage battery by a rated capacity. When the storage battery of 1 Ah is charged and discharged at 1 A, the C rate becomes 1 C and when the storage battery of 1 Ah is charged and discharged at 10 A, the C rate becomes 10 C. The lead-acid battery usually has 1 C for discharge and about 0.5 C for charge. Then, when the lead-acid battery is used, the battery capacity needs to be decided by the charging rate in a case where power is absorbed as illustrated in FIG. 5, and as a result, only 50% of the original output is used as output performance. Accordingly, in the present embodiment, a way of coping with charge and discharge is performed in such a way that the discharge, which the lead-acid battery is good at, is performed by the battery and the outputs of the inertial energy and the renewable energy are suppressed for the charge which the lead-acid battery is not good at.

### Embodiment 3

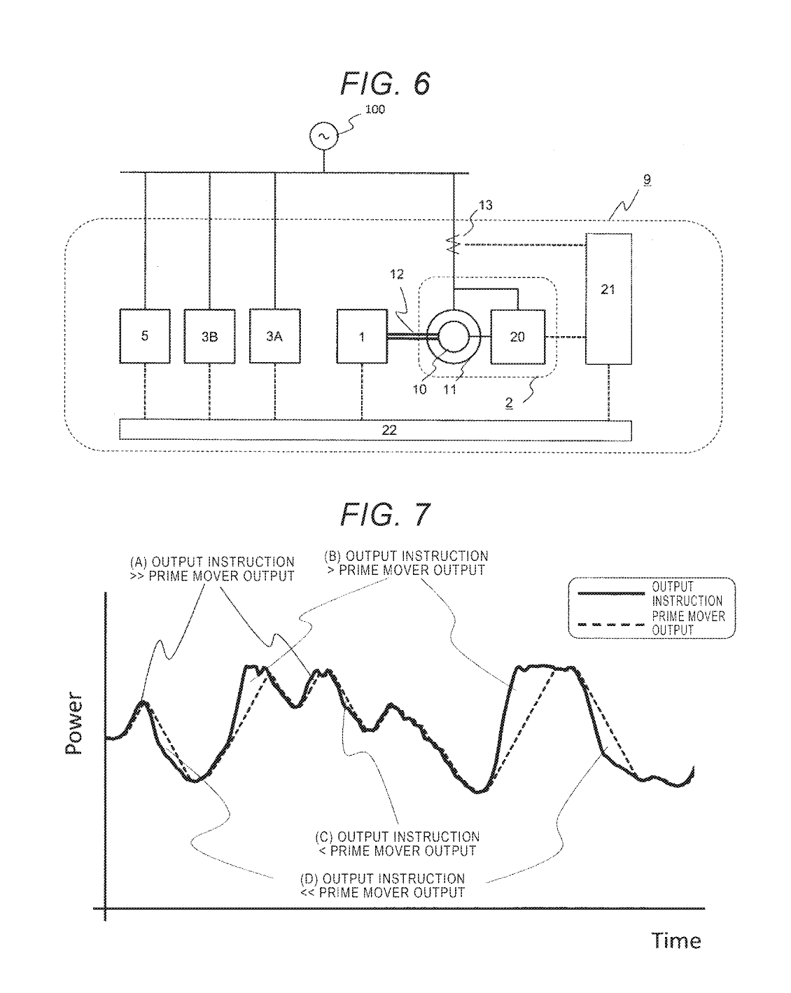

FIG. 6 illustrates a method of using a plurality of types of secondary batteries as a third embodiment of the present invention. The reference numeral 3A in FIG. 6 is a high power type battery and the reference numeral 3B is a high capacity type battery. Secondary batteries can be broadly classified into a high power type and a high capacity type. For example, even though the high power type is a lithium-ion battery or a nickel-metal hydride battery and the capacity is small, the output can be large but the cost per energy capacity is high. In contrast, the high capacity type is a lead-acid battery, a NAS battery, or the like and the cost per capacity is low, but in order to output high power, multiple-parallelization is needed and the cost is increased. In the renewable energy power supply, for example, in the case of photovoltaic power generation, the output may be reduced by about 80% in several tens of seconds due to movement of clouds, and the output of the fluctuation compensation battery needs to be approximately the same as the output of renewable energy. For that reason, in order to cope with a short-time output change, the high power type battery is used. On the other hand, the time that the sun is hidden in the cloud is not decided, a required energy capacity of the battery is determined by the time until the generation apparatus or other than the battery follows the output fluctuation of renewable energy. The high capacity type battery copes with this. In addition to the combination of the high power type battery and high capacity type battery, when the inertial energy of the doubly-fed induction generator 2 is used as described in Embodiments 1 and 2, it is possible to save secondary batteries, particularly high power type battery of which the cost is high.

### Embodiment 4

FIG. 7 illustrates a fourth embodiment of the present invention. Here, renewable energy randomly fluctuates with time and thus, an example of a case in which the output waveform instructions of the power generation system suppressing the fluctuation are randomly disordered. This is the case where the output change of the prime mover does not follow the output instruction. Regions (A) and (B) are cases where the output of the prime mover is smaller than the output instruction. The difference between the regions (A) and (B) is that there is a small difference in the region (A) and there is a large difference in the region (B). In the region (A), the output is slightly insufficient, the speed of the rotor can be lowered and the inertial energy can be released and supplemented. In the region (B), the output is largely insufficient and is supplemented by the battery.

Regions (C) and (D) are cases where the output of the prime mover is larger than the output instruction. The difference between the areas (C) and (D) is that there is a little difference in the region (C) and there is a large difference in the region (D). When there is a little difference as in the region (C), the difference can be supplemented by just the inertial energy. However, as illustrated in the region (D), in a case where the difference is large and the time, during which the difference is large, continues for a long time, the inertial energy becomes insufficient and thus, it is necessary to narrow down the output of the renewable energy. As such, the output instructions are divided into types for the case of surplus and the case of insufficiency and the apparatuses to perform output control are changed and the instructions are distributed to the apparatuses appropriately so as to make it possible to suppress the required batteries.

### Embodiment 5

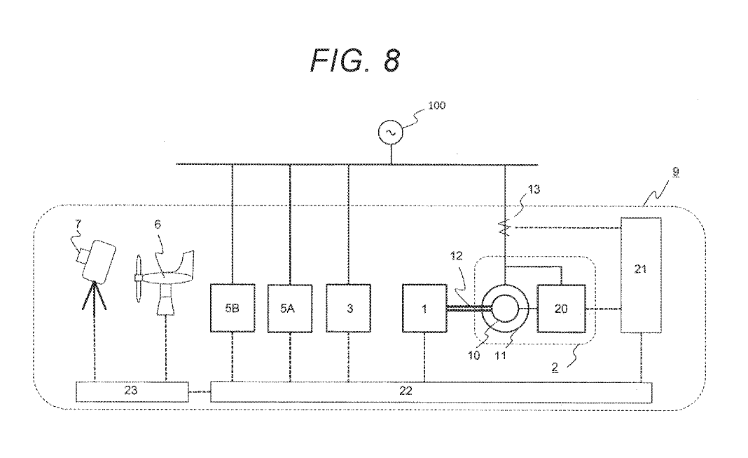

FIG. 8 illustrates a fifth embodiment of the present invention. FIG. 8 corresponds to an example in which a photovoltaic power generation apparatus denoted by 5A and a wind power generation apparatus denoted by 5B are installed as the renewable energy source with the same configuration as in FIG. 1, an anemometer 6 and a weather observation camera 7 are connected to a power generation amount forecast computation device 23, and the signal of power generation amount forecast computation device 23 is communicated with the integrated control device 22. The anemometer 6 is installed in the vicinity away from the wind power generation apparatus 5B and the power generation amount forecast computation device 23 predicts the output of the wind power generation apparatus 5B several seconds before. The weather observation camera 7 observes movement of the sun and the cloud and performs image processing on the observed image by power generation amount forecast computation device 23 so that the output of the photovoltaic power generation apparatus 5A can be predicted several seconds before. In the control according to the present embodiment, prior to the output prediction which is performed several seconds before by the anemometer 6 and the weather observation camera 7, the rotor 10 of the doubly-fed induction generator 2 is at standby changing the speed thereof. When it is predicted that the output of the photovoltaic power generation apparatus 5A or the wind power generation apparatus 5B will abruptly rises after a few seconds, the speed of the rotor 10 is lowered in advance. With this, the energy that can be absorbed until the speed of the rotor 10 reaches the upper limit can be increased and the power to be absorbed by the secondary battery 3 can be reduced. Otherwise, in contrast, when it is predicted that the output of the renewable energy apparatus will drop abruptly, the speed of the rotor 10 is increased in advance so as to make it possible to increase the output energy from the doubly-fed induction generator. As such, effect of the present embodiment can be further increased, so that the required capacity of the battery can be reduced. Further, regarding the control for suppressing the output of the renewable energy illustrated in FIG. 3, it is possible to apply an operation using the power generation amount prediction described above or the like.

As described above, in the present embodiment, the abrupt output change of the secondary battery can be supplemented by the output control of the inertial energy and the renewable energy and thus, it is possible to suppress the output of the secondary battery and realize an inexpensive hybrid power generation system by reducing the output of the battery, particularly the required capacity of the high power type battery. Deterioration of the secondary battery is progressed due to rapid charging and discharging, so that the service life of the battery can be prolonged as another effect of the present embodiment.

1. A power supply system comprising:
a prime mover that utilizes fuel;
a doubly-fed rotary machine that is connected to the prime mover and generates power;
a power converter that is connected to a rotor of the doubly-fed rotary machine; and
a renewable energy power supply,
wherein frequency control is performed against fluctuation of a system having a first period by the power converter, curtailment control is performed on an output of the renewable energy against fluctuation of a system having a second period longer than the first period, and the prime mover is controlled against fluctuation of a system having a third period longer than the second period.

2. The power supply system according to claim 1, further comprising:
a secondary battery,
wherein in a case where power is insufficient, an output is supplemented by the secondary battery.

3. The power supply system according to claim 2,
wherein the secondary battery is a lead-acid battery.

4. The power supply system according to claim 2,
wherein in a case where power is excessive, power is absorbed by the secondary battery, and in a case where power is insufficient, frequency control is performed on AC power to be supplied to the rotor so as to supplement the output by the secondary battery at the same time while discharging power by decreasing rotation speed.

5. The power supply system according to claim 2,
wherein the secondary battery includes a plurality of types of secondary batteries of which capacities and outputs are different and in a case where abrupt power is output or absorbed, the type of secondary battery for which importance is put on an output is preferentially controlled.

6. The power supply system according to claim 5,
wherein the secondary battery for which importance is put on an output is a lithium ion battery.

7. The power supply system according to claim 1, further comprising:
an air flow quantity or solar radiation quantity measurement apparatus; and
a computation unit that computes the air flow quantity or solar radiation quantity and predicts a power generation amount,
wherein rotation speed of the doubly-fed induction generator is changed in advance according to the prediction.

8. The power supply system according to claim 1, further comprising:
an air flow quantity or solar radiation quantity measurement apparatus; and
a computation unit that computes the air flow quantity or solar radiation quantity and predicts a power generation amount,
wherein in a case where it is predicted that a power generation amount of renewable energy is abruptly increased, an output of a renewable energy apparatus is suppressed and is gently changed.

9. A control method of a power supply system which is configured to include a prime mover that utilizes fuel, a doubly-fed rotary machine that is connected to the prime mover and generates power, a power converter that is connected to a rotor of the doubly-fed rotary machine, and a renewable energy power supply, the control method comprising:
performing frequency control against fluctuation of a system having a first period by a power converter;
performing curtailment control on an output of renewable energy against fluctuation of the system having a second period longer than the first period; and
controlling the prime mover against fluctuation of the system having a third period longer than the second period.
